(19) United States
(12) Patent Application Publication
(10) Pub. No.: US 2023/0366266 A1
(43) Pub. Date: Nov. 16, 2023

(54) METHOD OF FABRICATING A SHADE PANEL

(71) Applicant: Teh Yor Co., Ltd., New Taipei City (TW)

(72) Inventor: Chien-Fong HUANG, City of Industry, CA (US)

(73) Assignee: Teh Yor Co., Ltd., New Taipei City (TW)

(21) Appl. No.: 18/315,276

(22) Filed: May 10, 2023

Related U.S. Application Data
(60) Provisional application No. 63/341,818, filed on May 13, 2022.

(51) Int. Cl. E06B 9/262

(52) U.S. Cl. CPC E06B 9/262; E06B 2009/2627

(57) ABSTRACT

A method of fabricating a shade panel includes forming a shade panel including a plurality of cells, wherein each of the cells has a front portion and a rear portion opposite to each other, stretching the shade panel, wherein each of the cells includes a bend in the front portion that protrudes away from the rear portion when the shade panel is stretched, and pressing the front portion including the bend and the rear portion against each other to form a crease in the front portion of each of the cells.

### CROSS-REFERENCE TO RELATED APPLICATION(S)

This application claims priority to US Provisional Patent Application No. 63/341,818 filed on May 13, 2022, the disclosure of which is hereby incorporated by reference.

### BACKGROUND

### 1. Field of the Invention

The present invention relates to window shades, in particular to a method for fabricating shade panels used in window shades.

### 2. Description of the Related Art

Some conventional window shades may use a panel comprised of multiple cells for covering a window opening. For example, some approaches propose that a plurality of transversal strips are attached to one another in overlapping relation to form the cells, each transversal strip being arranged to alternately form a front and a rear of adjacent cells. These approaches require processing steps that are relatively complex and not cost-effective. Moreover, the cells may not collapse and expand as desired during use, which may affect the outer appearance of the panel and the ability of the cells to provide thermal insulation.

### SUMMARY

The present application describes a method of fabricating a shade panel that can address at least some of the aforementioned issues.

According to one aspect, a method of fabricating a shade panel includes forming a shade panel including a plurality of cells, wherein each of the cells has a front portion and a rear portion opposite to each other, stretching the shade panel, wherein each of the cells includes a bend in the front portion that protrudes away from the rear portion when the shade panel is stretched, and pressing the front portion including the bend and the rear portion against each other to form a crease in the front portion of each of the cells.

### BRIEF DESCRIPTION OF THE DRAWINGS

FIG. 1 is a perspective view illustrating an embodiment of a window shade;

FIG. 2 is a front view illustrating the window shade of FIG. 1;

FIG. 3 is a side view illustrating the window shade of FIG. 1;

FIG. 4 is an exploded view of the window shade shown in FIG. 1;

FIG. 5 is a flowchart illustrating some processing steps in a method for fabricating a shade panel;

FIGS. 6-8 are schematic views illustrating some examples of intermediate stages in the method of FIG. 5;

FIG. 9 is a schematic view illustrating an embodiment of a shade panel formed in an initial step of the method shown in FIG. 5;

FIG. 10 is a schematic view illustrating an elongate strip used for forming the shade panel shown in FIG. 9;

FIG. 11 is a schematic view illustrating a variant embodiment of a shade panel formed in the initial step of the method shown in FIG. 5;

FIG. 12 is a schematic view illustrating an elongate strip used for forming the shade panel shown in FIG. 11;

FIGS. 13-15 are schematic views illustrating some examples of intermediate stages in the method of FIG. 5, wherein the initial step of the method forms the shade panel as shown in FIG. 11;

FIG. 16 is a schematic view illustrating another variant embodiment of the shade panel formed in the initial step of the method shown in FIG. 5;

FIGS. 17-19 are schematic views illustrating some examples of intermediate stages in the method of FIG. 5, wherein the initial step of the method forms the shade panel as shown in FIG. 16; and

FIG. 20 is a schematic view illustrating a further processing step for removing a front portion of a bottom cell while leaving a rear portion thereof for attachment to a rail.

### DETAILED DESCRIPTION OF THE EMBODIMENTS

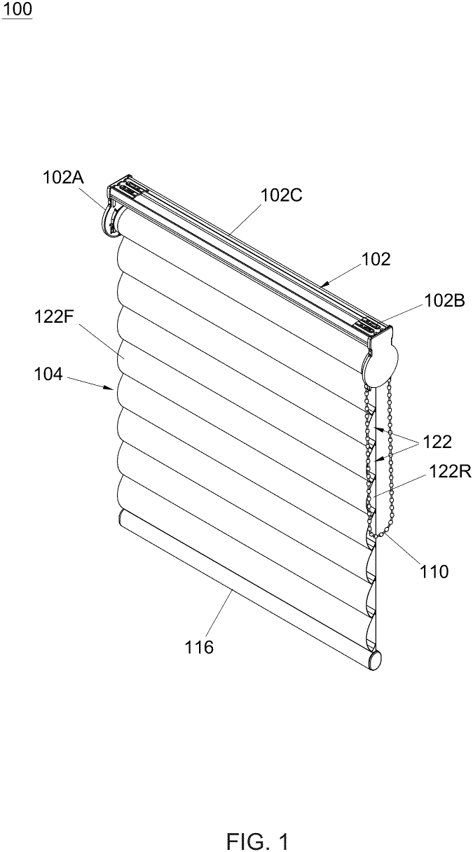

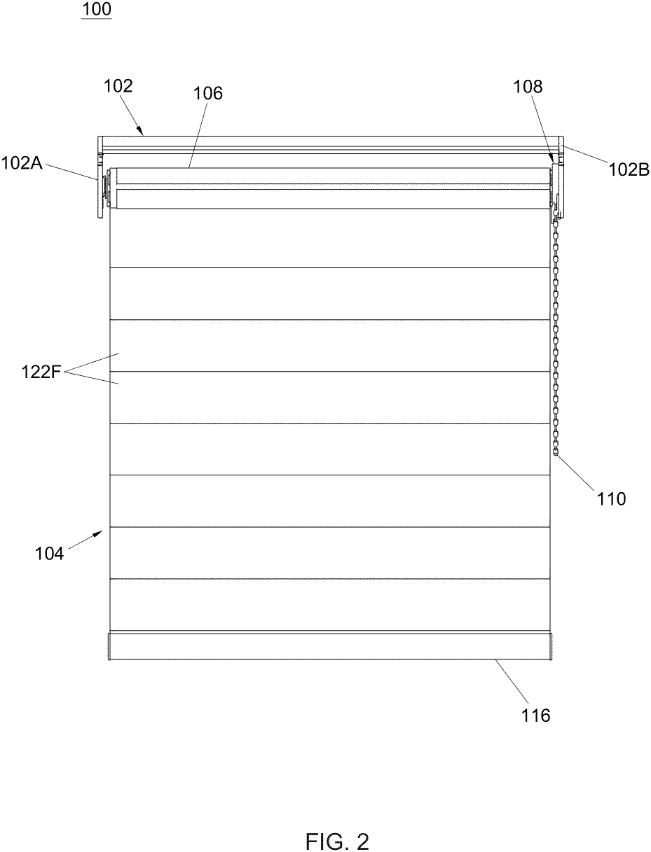

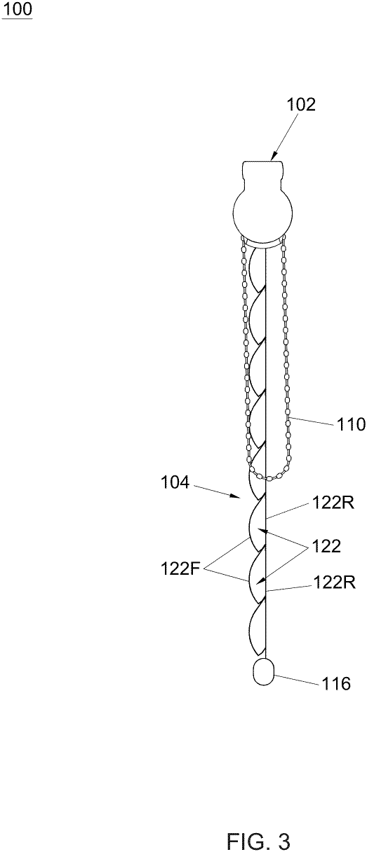

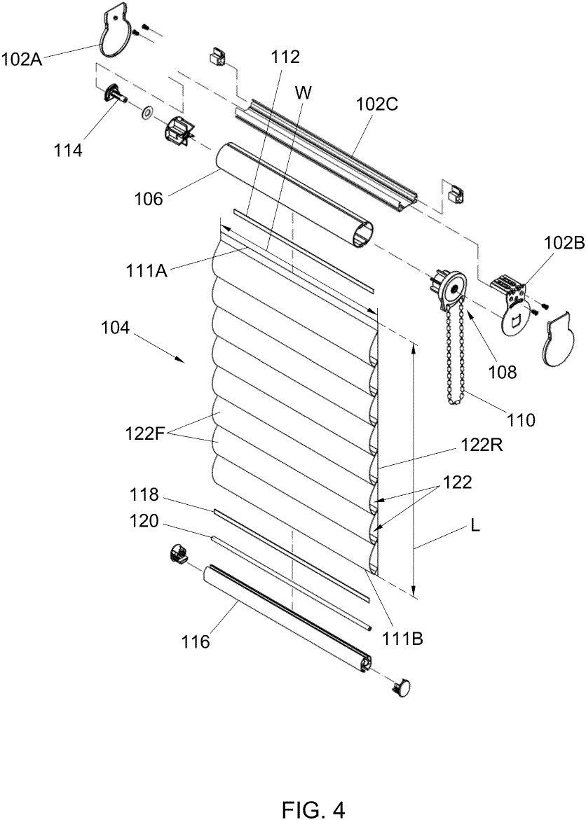

FIG. 1 is a perspective view illustrating an embodiment of a window shade 100, FIGS. 2 and 3 are respectively a front and a side view of the window shade 100, and FIG. 4 is an exploded view illustrating some construction details of the window shade 100. Referring to FIGS. 1-4, the window shade 100 can include a head frame 102, a shade panel 104, and an actuating system assembled with the head frame 102 for controlling the movement of the shade panel 104.

The actuating system may include a roller 106, and a control device 108 having an operating member 110. The roller 106 is connected to an end 111A of the shade panel 104, and is pivotally connected to the head frame 102. According to an example of construction, the roller 106 may be connected to the shade panel 104 by inserting an anchor strip 112 coupled to the end 111A of the shade panel 104 inside a slot in the roller 106. The head frame 102 can include two side brackets 102A and 102B attached to an elongate rail 102C, and the roller 106 can have one end pivotally connected about a fixed shaft 114 that is fixedly connected to the side bracket 102A. The control device 108 is coupled to the other end of the roller 106, and is mounted to the side bracket 102B with the operating member 110 extending outside the head frame 102. Examples of the operating member 110 can include, without limitation, closed-loop elements such as bead chains. With this construction, the roller 106 is rotatable to wind and unwind the shade panel 104, and the operating member 110 is operable to drive the roller 106 in rotation in either direction.

Referring to FIGS. 1-4, the shade panel 104 has a length L along a first direction, and a width W along a second direction orthogonal to the first direction. The shade panel 104 includes a plurality of cells 122 distributed adjacent to one another along the length L, each cell 122 extending along the width W and having a hollow interior. Each cell 122 has a front portion 122F and a rear portion 122R opposite to each other. When the shade panel 104 is expanded, the rear of the cells 122 can be generally planar, whereas the front of the cells 122 can have a wave-shaped profile. When the shade panel 104 is expanded for use in a building, the front portions 122F of the cells 122 face indoor, and the expanded cells 122 can form a layer of air that can assist in providing thermal insulation.

Referring to FIGS. 1-4, the end 111A of the shade panel 104 is adapted to connect to the roller 106, and another end 111B of the shade panel 104 opposite to the end 111A may be connected to a rail 116. The rail 116 extends along the width W of the shade panel 104, and serves as a weighing element that can assist in expanding and stabilizing the shade panel 104 during use. According to an example of construction, the end 111B of the shade panel 104 can be attached to an anchor strip 118. The anchor strip 118 can be disposed inside a hollow interior of the rail 116, and a restricting part 120 can be fitted into the rail 116 so as to hold a portion of the shade panel 104 inside the rail 116.

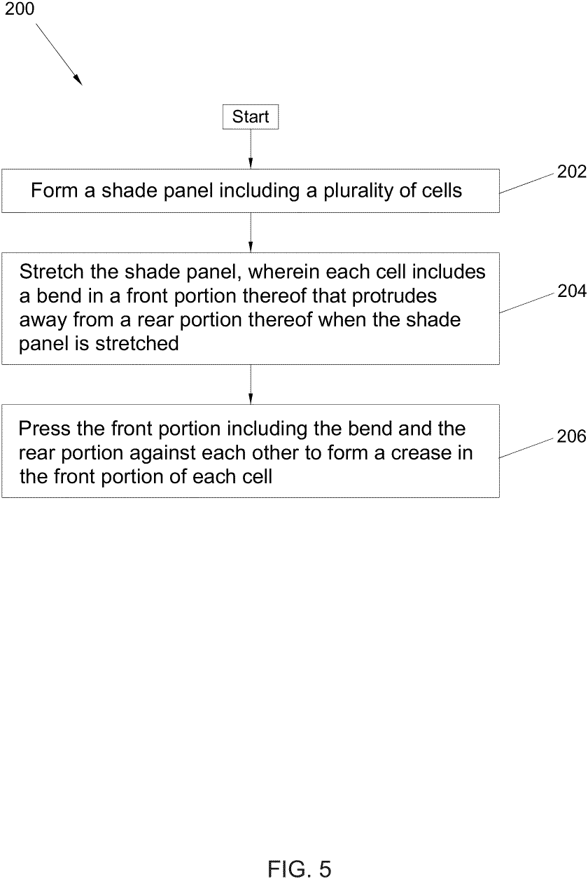

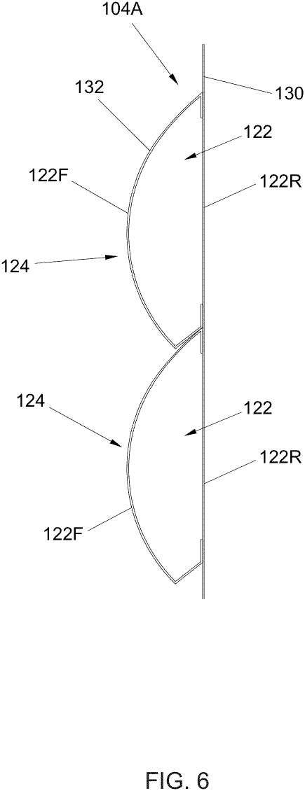

In conjunction with FIGS. 1-4, FIG. 5 is a flowchart illustrating processing steps in a method 200 for fabricating the shade panel 104, and FIGS. 6-8 are schematic views illustrating some examples of intermediate stages in the method 200 of FIG. 5. Referring to FIGS. 5 and 6, a shade panel 104A including the cells 122 is formed in initial step 202, wherein each of the cells 122 has the front portion 122F and the rear portion 122R opposite to each other.

In step 204, the shade panel 104A is stretched, wherein each cell 122 includes a bend 124 in the front portion 122F that protrudes away from the rear portion 122R when the shade panel 104A is stretched. Stretching the shade panel 104A can cause the rear portion 122R of each cell 122 to extend generally along a same plane. Meanwhile, the bends 124 in the front portions 122F of the cells 122 can form a wave-shaped profile.

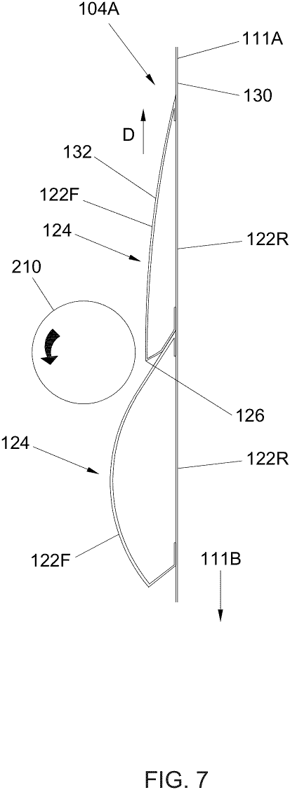

Referring to FIGS. 5 and 7, in next step 206, the front portion 122F including the bend 124 and the rear portion 122R then are pressed against each other to form a crease 126 in the front portion 122F of each cell 122. For example, step 206 can include passing the stretched shade panel 104A through a pressing roller 210 in a direction D so that the pressing roller 210 contacts and presses the front portion 122F against the rear portion 122R of each cell 122. In particular, the shade panel 104A can be passed through the pressing roller 210 from the end 111A to the end 111B of the shade panel 104A, the end 111A of the shade panel 104A corresponding to the end attachable to the roller 106 of the window shade 100.

Referring to FIG. 7, pressing the front portion 122F against the rear portion 122R can flatten the bend 124. As the bend 124 is gradually flattened, the pressing roller 210 can urge a squeezed portion formed in the front portion 122F forward of the pressing roller 210 to fold over the rear portion 122R, thereby forming the crease 126.

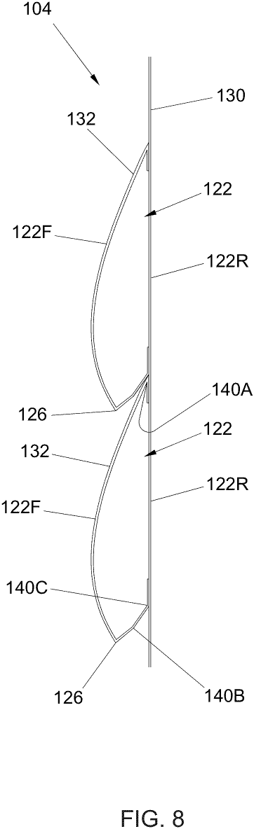

FIG. 8 illustrates the shade panel 104 obtained after step 206 is completed. In the shade panel 104, each cell 122 includes the crease 126 in the front portion 122F thereof. The crease 126 forms a hinge that can facilitate collapse and expansion of the cell 122 when the shade panel 104 is wound and extended from the roller 106.

In conjunction with FIGS. 5-8, FIGS. 9 and 10 are schematic views illustrating an embodiment of the shade panel 104A formed in step 202. Referring to FIGS. 5, 9 and 10, step 202 of the method 200 can include providing a support sheet 130, providing a plurality of elongate strips 132, and bonding the elongate strips 132 to the support sheet 130 to form the cells 122 of the shade panel 104A, wherein the front portion 122F of each of the cells 122 is formed by one of the elongate strips 132, and the rear portion 122R of each of the cells 122 is formed by the support sheet 130.

The elongate strips 132 are similar in construction. Each elongate strip 132 can have two longitudinal edges 134A and 134B opposite to each other, and a main strip portion 136 located between two margins 138A and 138B. The margin 138A adjoins the main strip portion 136 along a folding line 140A and extends between the folding line 140A and the longitudinal edge 134A. The other margin 138B adjoins the main strip portion 136 along another folding line 140B and extends between the folding line 140B and the longitudinal edge 134B. The folding lines 140A and 140B are generally parallel to each other and extend along the lengthwise direction (i.e., corresponding to the width W of the shade panel 104) of the elongate strip 132. Moreover, the margin 138B includes a folding line 140C that is generally parallel to the folding lines 140A and 140B and is located between the folding line 140B and the longitudinal edge 134B. The margin 138B thereby has a margin portion 142A extending between the longitudinal edge 134B and the folding line 140C, and a margin portion 142B extending between the two folding lines 140B and 140C.

Various methods may be applied to form the folding lines 140A, 140B and 140C in each elongate strip 132. For example, each of the folding lines 140A, 140B and 140C may be a perforation line including a plurality of perforations spaced apart from one another that are pierced through the elongate strip 132. According to another example, each of the folding lines 140A, 140B and 140C may be a crease, which may be formed with a rolling blade that is pressed against the elongate strip 132. The method applied for forming the folding lines 140A, 140B and 140C may be selected according to the thickness of the elongate strip 132 and/or the materials of the elongate strip 132.

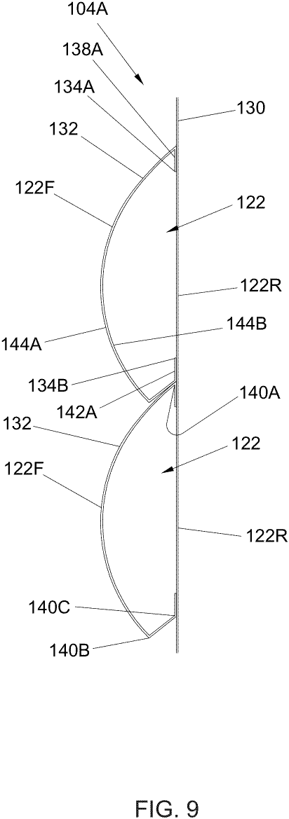

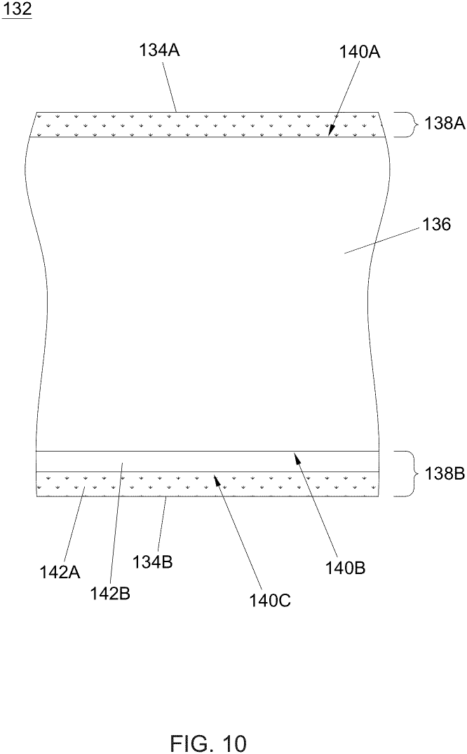

Referring to FIGS. 9 and 10, the cells 122 of the shade panel 104A can be formed by bonding the elongate strips 132 to the support sheet 130. More specifically, the margin 138A of each elongate strip 132 can be bonded to the support sheet 130, and the margin 138B of each elongate strip 132 can be bonded to the support sheet 130 at the margin portion 142A between the longitudinal edge 134B and the folding line 140C, the margin 138B being unbonded to the support sheet 130 at the margin portion 142B between the two folding lines 140B and 140C. Examples of techniques applied for bonding the elongate strips 132 include, without limitation, adhesive bonding, ultrasonic bonding, and the like.

In the example of FIG. 9, the elongate strip 132 can have two opposite strip surfaces 144A and 144B extending between the two opposite longitudinal edges 134A and 134B, and the margin 138A and the margin portion 142A can be bonded on the same strip surface 144A to the support sheet 130. For example, the margin 138A of the elongate strip 132 can have a first adhesive layer applied on the strip surface 144A thereof, and the margin portion 142A of the elongate strip 132 can have a second adhesive layer applied on the same strip surface 144A thereof. The elongate strip 132 then can be disposed so that the margin 138A of the elongate strip 132 is bonded to the support sheet 130 with the first adhesive layer, and the margin portion 142A of the elongate strip 132 is bonded to the support sheet 130 with the second adhesive layer at a location spaced apart from the margin 138A. The elongate strips 132 can be likewise bonded to the support sheet 130 adjacent to one another to form the cells 122 of the shade panel 104A.

It will be appreciated that the way of bonding the elongate strips 132 is not limited to the aforementioned example. According to another example, the margin 138A and the margin portion 142A of each elongate strip 132 may be bonded on different ones of the strip surfaces 144A and 144B to the support sheet 130. According to another variant example, the margin 138A of the elongate strip 132 may be bonded to the support sheet 130, and the margin portion 142A of the elongate strip 132 may be bonded to another elongate strip 132 adjacent thereto.

Referring to FIGS. 5, 8 and 9, step 206 can form a crease 126 in each of the elongate strips 132 between the two folding lines 140A and 140B thereof. When the shade panel 104 thereby formed is expanded, a lowest end of each cell 122 can be defined by the crease 126. When one cell 122 is collapsed owing to winding of the shade panel 104 around the roller 106, the front portion 122F can lie closely to the rear portion 122R.

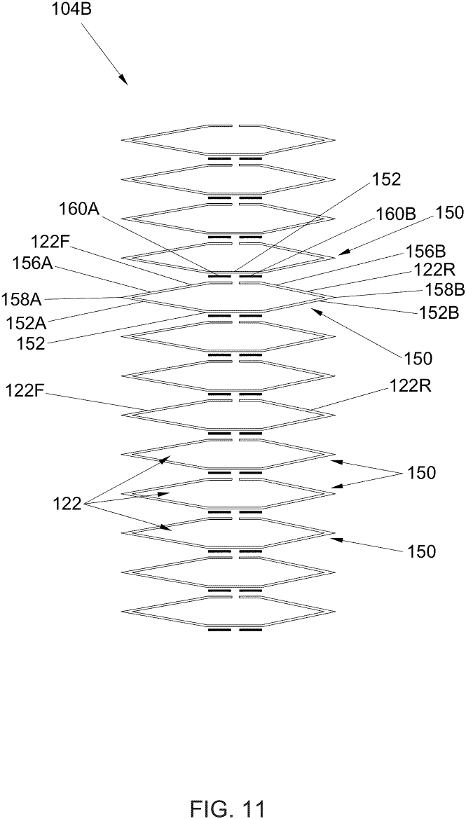

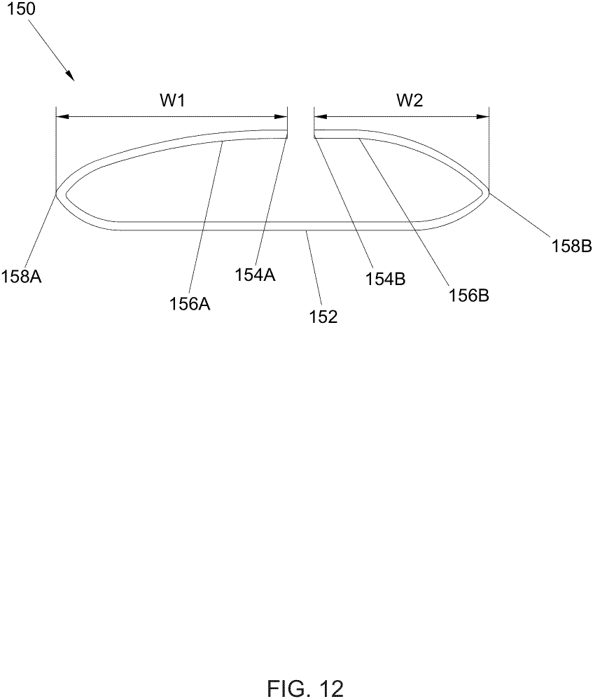

In conjunction with FIG. 5, FIGS. 11 and 12 are schematic views illustrating a variant embodiment of a shade panel 104B that may be formed in step 202 of the method 200. Referring to FIGS. 5, 11 and 12, step 202 of the method 200 can include providing a plurality of elongate strips 150, and bonding the elongate strips 150 to one another to form the cells 122 of a shade panel 104B.

According to an example of construction, each of the elongate strips 150 includes a central portion 152, two longitudinal edges 154A and 154B opposite to each other, and two longitudinal portions 156A and 156B that are respectively folded over the central portion 152 along two folding lines 158A and 158B. In each of the elongate strips 150, the longitudinal portion 156A has a width W1 between the longitudinal edge 154A and the folding line 158A, and the longitudinal portion 156B has a width W2 between the longitudinal edge 154B and the folding line 158B that is smaller than the width W1 of the longitudinal portion 156A. In other words, the ratio W1/W2 is greater than 1.

The cells 122 of the shade panel 104B can be formed by bonding the elongate strips 150 to one another, wherein two adjacent ones of the elongate strips 150 are bonded to each other by bonding the longitudinal portions 156A and 156B of one of the two adjacent elongate strips 150 to the central portion 152 of the other one of the two adjacent elongate strips 150. For example, a first and a second adhesive layer 160A and 160B can be respectively applied on the two longitudinal portions 156A and 156B of a first elongate strip 150, and a second elongate strip 150 then can be disposed so that the central portion 152 of the second elongate strip 150 is bonded to the two longitudinal portions 156A and 156B of the first elongate strip 150 with the first and second adhesive layers 160A and 160B. The elongate strips 150 can be likewise bonded to one another to form the cells 122 of the shade panel 104B. In each cell 122 of the shade panel 104B, the front portion 122F of the cell 122 is formed by a portion of the elongate strip 150 including the longitudinal portion 156A and a first region 152A of the central portion 152 adjoining the folding line 158A, and the rear portion 122R of the cell 122 is formed by a portion of the elongate strip 150 including the longitudinal portion 156B and a second region 152B of the central portion 152 adjoining the folding line 158B.

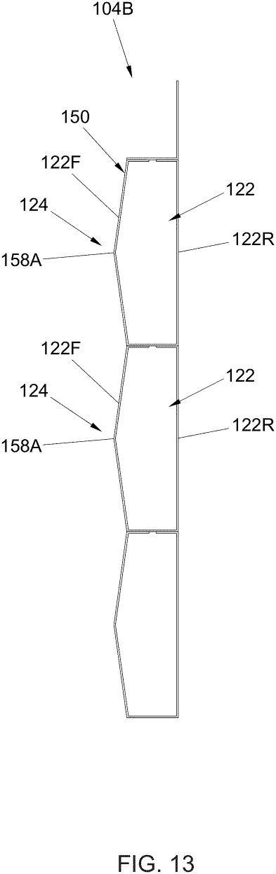

FIGS. 13-15 are schematic views illustrating some examples of intermediate stages in the method 200 of FIG. 5, wherein step 202 of the method 200 forms the shade panel 104B shown in FIG. 11.

Referring to FIGS. 5 and 13, the shade panel 104B is stretched in step 204, wherein each cell 122 includes a bend 124 in the front portion 122F that protrudes away from the rear portion 122R when the shade panel 104B is stretched. The bends 124 in the front portions 122F of the cells 122 can form a wave-shaped profile. Meanwhile, stretching the shade panel 104B causes the rear portion 122R of each cell 122 to extend generally along a same plane. In particular, the longitudinal portion 156B and the second region 152B of the central portion 152 (better shown in FIG. 11) in each elongate strip 150 can be stretched so as to extend generally along a same plane.

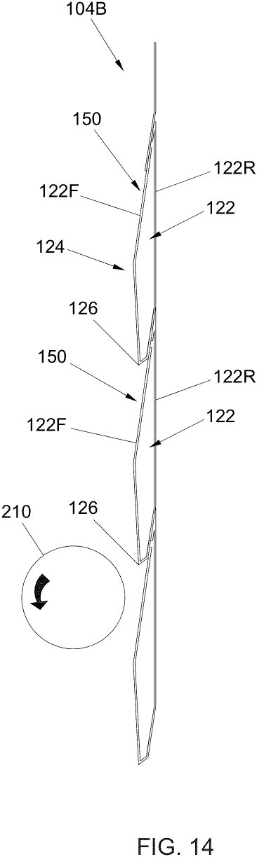

Referring to FIGS. 5 and 14, pressing the front portion 122F against the rear portion 122R in step 206 can flatten the bend 124. As the bend 124 is gradually flattened, the pressing roller 210 can urge a squeezed portion formed in the front portion 122F forward of the pressing roller 210 to fold over the rear portion 122R, thereby forming the crease 126.

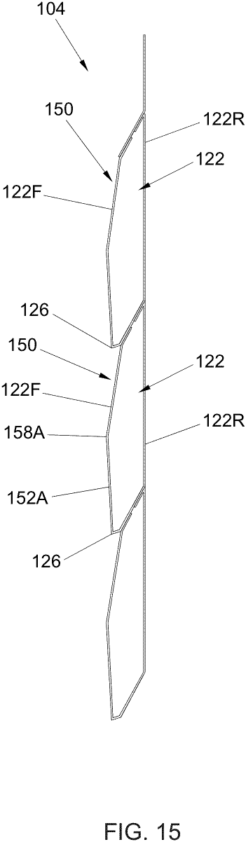

Referring to FIGS. 5 and 15, after step 206 is completed, each cell 122 of the formed shade panel 104 includes the crease 126 in the first region 152A of the central portion 152 of the elongate strip 150. The crease 126 forms a hinge that can facilitate collapse and expansion of the cell 122 when the shade panel 104 is wound around and extended from the roller 106.

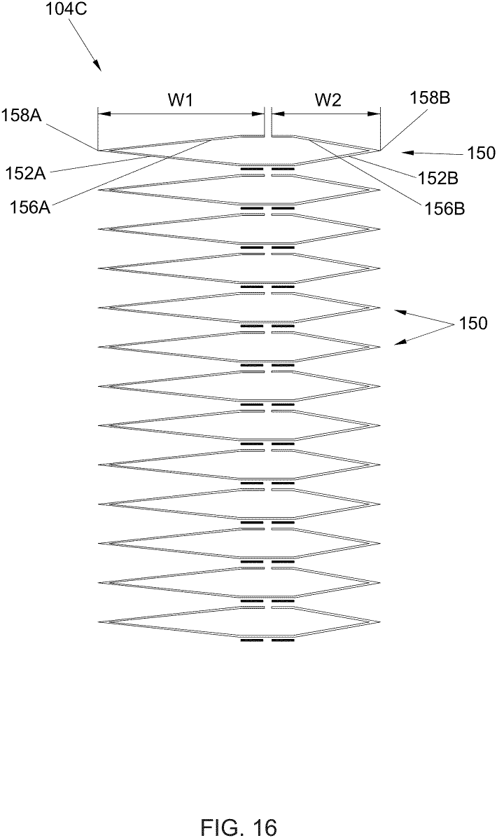

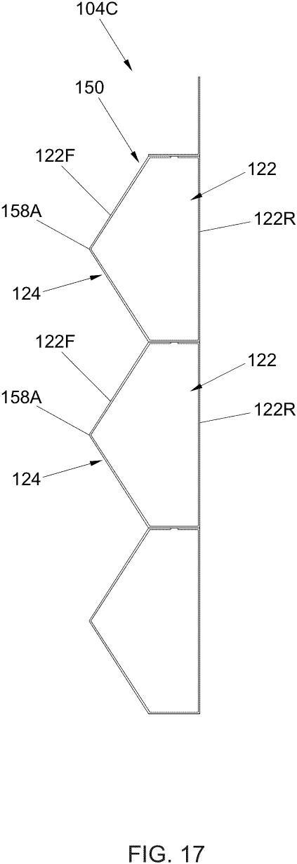

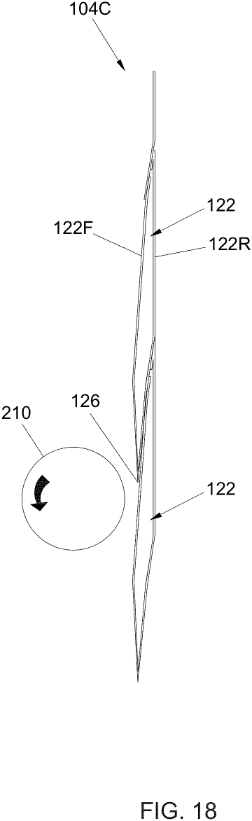

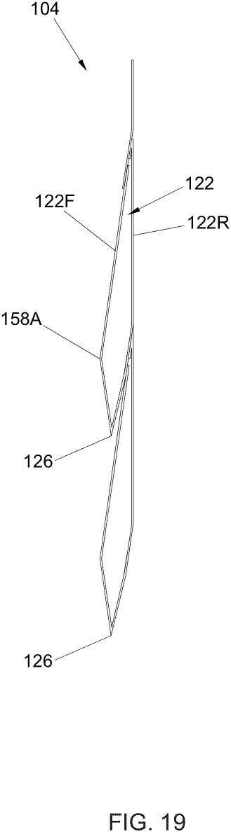

Depending upon the ratio W1/W2 (better shown in FIG. 12) in each elongate strip 150, the cells 122 of the shade panel 104 obtained with the method 200 may have different shapes. FIG. 16 illustrates a variant example in which each elongate strip 150 used for forming the shade panel 104C in step 202 has a ratio W1/W2 that is greater than the ratio W1/W2 of the example shown in FIGS. 11 and 12. FIGS. 17 and 18 illustrate the shade panel 104C undergoing steps 204 and 206 of the method 200 as described previously, and FIG. 19 illustrates the shade panel 104 obtained after completion of step 206.

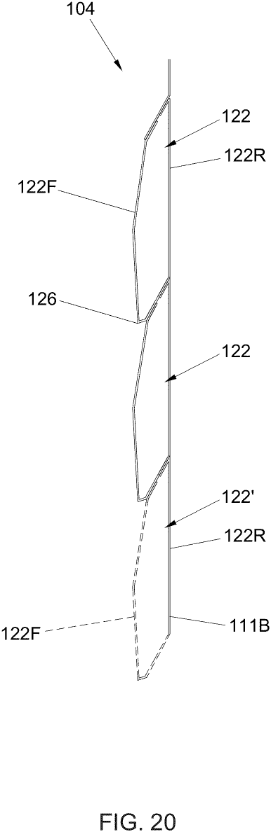

Referring to FIG. 20, the method can further include removing the front portion 122F of a bottom cell 122′ (shown with phantom lines in FIG. 20) while keeping the rear portion 122R of the bottom cell 122′ to form the end 111B of the shade panel 104 for attachment to the rail 116 (better shown in FIG. 4). For example, the front portion 122F of the bottom cell 122′ may be cut and removed so that the remaining rear portion 122R of the bottom cell 122′ can form a tail adapted to be attached to the rail 116. This step may be optionally applied as needed. For example, the step of removing the front portion 122F of the bottom cell 122′ may be performed when the shade panel 104 is fabricated based on the construction shown in FIGS. 11 or 16.

Advantages of the methods and structures described herein include the ability to provide shade panels having suitable creases to facilitate the collapse and expansion of the cells of the shade panels. The creases can be added in the cells via a pressing step after the shade panel is formed, which is adapted for shade panels having cells of different structures and facilitates the manufacture process.

Realization of the methods and structures have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. A method of fabricating a shade panel, comprising:
forming a shade panel including a plurality of cells, wherein each of the cells has a front portion and a rear portion opposite to each other;
stretching the shade panel, wherein each of the cells includes a bend in the front portion thereof that protrudes away from the rear portion thereof when the shade panel is stretched; and
pressing the front portion including the bend and the rear portion against each other to form a crease in the front portion of each of the cells.

2. The method according to claim 1, wherein the step of pressing the front portion including the bend and the rear portion against each other causes flattening of the bend and results in a squeezed portion in the front portion that is folded over the rear portion to form the crease.

3. The method according to claim 1, wherein the step of stretching the shade panel causes the rear portion of each of the cells to extend generally along a same plane.

4. The method according to claim 1, wherein the step of pressing the front portion including the bend and the rear portion against each other includes passing the stretched shade panel through a pressing roller so that the pressing roller contacts and presses the front portion against the rear portion.

5. The method according to claim 4, wherein the shade panel has a first end and a second end opposite to each other, the shade panel being attachable to a roller of a window shade at the first end, the shade panel passing through the pressing roller from the first end to the second end.

6. The method according to claim 1, wherein the step of forming a shade panel including a plurality of cells comprises:
providing a support sheet;
providing a plurality of elongate strips; and
bonding the elongate strips to the support sheet to form the cells, wherein the front portion of each of the cells is formed by one of the elongate strips, and the rear portion of each of the cells is formed by the support sheet.

7. The method according to claim 6, wherein each of the elongate strips has a first and a second longitudinal edge opposite to each other, and a main strip portion located between a first and a second margin, the first margin adjoining the main strip portion along a first folding line and extending between the first folding line and the first longitudinal edge, the second margin adjoining the main strip portion along a second folding line and extending between the second folding line and the second longitudinal edge, the second margin including a third folding line generally parallel to the second folding line.

8. The method according to claim 7, wherein the step of bonding the elongate strips to the support sheet comprises:
bonding the first margin of each of the elongate strips to the support sheet; and
bonding the second margin of each of the elongate strips to the support sheet at a first margin portion between the third folding line and the second edge, the second margin being unbonded to the support sheet at a second margin portion between the second folding line and the third folding line.

9. The method according to claim 8, wherein the step of pressing the front portion including the bend and the rear portion against each other forms the crease in each of the elongate strips between the first folding line and the second folding line thereof.

10. The method according to claim 1, wherein the step of forming a shade panel including a plurality of cells comprises:
providing a plurality of elongate strips, wherein each of the elongate strips includes a central portion, a first longitudinal edge and a second longitudinal edge opposite to each other, and a first longitudinal portion and a second longitudinal portion respectively folded over the central portion along a first folding line and a second folding line; and
bonding the elongate strips to one another to form the cells, wherein two adjacent ones of the elongate strips are bonded to each other by bonding the first longitudinal portion and the second longitudinal portion of one of the two adjacent elongate strips to the central portion of the other one of the two adjacent elongate strips.

11. The method according to claim 10, wherein in each of the elongate strips, the first longitudinal portion has a width between the first longitudinal edge and the first folding line, and the second longitudinal portion has a width between the second longitudinal edge and the second folding line that is smaller than the width of the first longitudinal portion between the first longitudinal edge and the first folding line.

12. The method according to claim 11, wherein the front portion of each of the cells is formed by the first longitudinal portion and a first region of the central portion of one of the elongate strips, and the rear portion of each of the cells is formed by the second longitudinal portion and a second region of the central portion of one of the elongate strips.

13. The method according to claim 12, wherein the step of stretching the shade panel causes the second longitudinal portion and the second region of the central portion of each of the elongate strips to extend generally along a same plane.

14. The method according to claim 12, wherein the step of pressing the front portion including the bend and the rear portion against each other forms the crease in the first region of the central portion of each of the elongate strips.

15. The method according to claim 1, wherein the cells include a bottom cell, and the method further comprises removing the front portion of the bottom cell while keeping the rear portion of the bottom cell.
